(19) United States
(12) Patent Application Publication
(10) Pub. No.: US 2023/0002859 A1
(43) Pub. Date: Jan. 5, 2023

(54) NANOCRYSTALLINE PLATINUM ALLOY LAYERS AND RELATED ARTICLES

(71) Applicant: Xtalic Corporation, Marlborough, MA (US)

(72) Inventors: Robert D. Hilty, Walpole, MA (US); Evgeniya Freydina, Acton, MA (US); Jeffrey C. Monroe, Worcester, MA (US); Malik M. Wagih, Boston, MA (US)

(73) Assignee: Xtalic Corporation, Marlborough, MA (US)

(21) Appl. No.: 17/366,766

(22) Filed: Jul. 2, 2021

(51) Int. Cl. C22C 5/04; B32B 15/01

(52) U.S. Cl. CPC C22C 5/04; B32B 15/018

(57) ABSTRACT

Platinum-based alloys comprising a second element are generally described. In some embodiments, the platinum-based alloy may comprise a third element.

### TECHNICAL FIELD

Nanostructured platinum-containing alloys are generally described.

### BACKGROUND

Rhodium can be used in the coating of electrical contacts on connectors, and the demand for such contacts is expected to rise as the demand for consumer and industrial electronic devices continues to rise. Rhodium-containing plated stacks have been previously described, such as the use of rhodium in combination with other metallic layers as a connector interface material. Rhodium may also be particularly effective at powered immersion corrosion resistance as the material is effective in electrolyzing water. However, while rhodium is hard and durable, it is relatively scarce and, as such, the cost of this metal can be prohibitively high and volatile. Thus, the need exists to identify alternative materials which may allow for the reduction or elimination of the use of rhodium in electronics applications.

### SUMMARY

Nanocrystalline platinum alloys are described herein. The subject matter of the present disclosure involves, in some cases, interrelated products, alternative solutions to a particular problem, and/or a plurality of different uses of one or more systems and/or articles.

In one aspect, an article is described comprising a first layer comprising an alloy, the alloy comprising platinum (Pt), and a second element comprising or selected from one of Mo, W, Pd, Au, Ag, Sb, and Bi, wherein an average grain size of the alloy is less than or equal 1000 nm.

In another aspect, method is described, the method comprising forming a first layer on a substrate, the first layer comprising an alloy comprising platinum (Pt) and a second element comprising or selected from one of Mo, W, Pd, Au, Ag, Sb, and Bi, wherein an average grain size of the alloy is less than or equal 1000 nm.

Other advantages and novel features of the present disclosure will become apparent from the following detailed description of various non-limiting embodiments of the invention when considered in conjunction with the accompanying figures. In cases where the present specification and a document incorporated by reference include conflicting and/or inconsistent disclosure, the present specification shall control.

### DETAILED DESCRIPTION

Platinum-containing alloys are generally described herein. These platinum alloys may be nanocrystalline, such that the grain sizes of the crystallites within the platinum alloy are of the nanoscale. Advantageously, platinum (Pt) can be an attractive alternative to rhodium in coatings for electrical contacts in that the availability of platinum is higher and cost is much lower than rhodium. Further, platinum may also be effective as a water-splitting catalyst, such that it can induce electrolysis of water, and it may also provide improved powered-immersion corrosion performance. Furthermore, certain platinum alloys may be resistant to corrosion and oxidation, making them suitable materials as a coating (e.g., a surface coating) for electrical connector applications. The platinum-based alloys described herein may be used to improve connector coating finishes and, in some cases, may reduce or eliminate the use of rhodium in these coatings and may also have other advantages. Additional advantages of the disclosed platinum alloys are described in more detail below.

While platinum metal may be relatively soft, it has been recognized and appreciated within the context of the present disclosure that nanocrystalline platinum-based alloys may advantageously have a hardness greater than that of pure platinum metal. That is to say, platinum can be alloyed (e.g., with a metal and/or a metalloid) to improve its performance (relative to pure platinum metal) with respect to key performance indicators, such as hardness, and other performance indicators such as wear durability, powered-immersion corrosion performance, salt spray endurance, heat age tolerance, and industrial mixed flowing gas corrosion resistance. The platinum alloys described herein may also exhibit improved hardness, reduced crystallite size, and more favorable performance in corrosion testing, namely in salt spray (ASTM B117) and powered-immersion corrosion testing.

As noted above, layers comprising platinum-based alloys may be employed. In some embodiments, platinum comprises the majority element present in the alloy. That is to say, in some embodiments, platinum content in the disclosed alloys is present in the highest amount (e.g., highest weight percentage (wt %)) relative to the remaining elements present in the alloy. In some embodiments, platinum is the solvent element of the alloy, and the remaining elements (e.g., a second element, a third element) are solute elements dissolved within the platinum. However, while various embodiments contain platinum as the majority or solvent element, in other embodiments, another element may be the majority element or the solvent element as this disclosure is not so limited.

In some embodiments, the amount of Pt present in the platinum alloy is greater than or equal to 33 wt %, greater than or equal to 50 wt %, greater than or equal to 75 wt %, greater than or equal to 80 wt %, greater than or equal to 90 wt %, or greater than or equal to 95 wt %, with the remaining balance being a second element and/or a third element. In some embodiments, the amount of Pt present in the platinum alloy is less than or equal to 95 wt %, less than or equal to 90 wt %, less than or equal to 80 wt %, less than or equal to 75 wt %, less than or equal to 50 wt %, or less than or equal to 33 wt %. Combinations of the foregoing ranges are also possible (e.g., greater than or equal to 33 wt % and less than or equal to 95 wt %). Of course, other ranges are possible at this disclosure is not so limited.

The platinum alloys disclosed herein may be nanocrystalline. As used herein, a “nanocrystalline” structure refers to a structure in which the number-average size of crystalline grains is less than one micron. In some embodiments, a grain size (e.g., an average grain size) of the nanocrystalline platinum alloy is less than or equal to 1000 nm, less than or equal to 900 nm, less than or equal to 800 nm, less than or equal to 700 nm, less than or equal to 600 nm, less than or equal to 500 nm, less than or equal 400 nm, less than or equal to 300 nm, less or equal to 200 nm, less than or equal to 100 nm, or less than or equal to 50 nm. In some embodiments, a grain size of the nanocrystalline platinum alloy is greater than or equal to 50 nm, greater than or equal to 100 nm, greater than or equal to 200 nm, greater than or equal to 300 nm, greater than or equal to 400 nm, greater than or equal to 500 nm, greater than or equal to 600 nm, greater than or equal to 700 nm, greater than or equal to 800 nm, or greater than or equal to 900 nm. Combinations of the foregoing ranges are also possible (e.g., greater than or equal to 50 nm and less than or equal to 1000 nm). Of course, other ranges are possible as this disclosure is not so limited. The grain size of the resulting alloy can be evaluated by techniques known in the art, e.g., microscopy techniques.

The platinum alloys described herein contain a second element. The second element may be selected such that it reduces or prevents phase segregation and/or grain growth within the alloy. That is, the second element may provide stability to the alloy such that the grain size of crystallites within the alloy maintain a particular structure (e.g., a nanostructure, a nanocrystalline structure). As mentioned above, it has been recognized and appreciated that the inclusion of a second element (and/or a third element) in the platinum may provide certain advantages relative to pure platinum metal. As a non-limiting example, platinum alloys containing platinum and a second element may be harder compared to pure platinum metal. Other advantages are possible, at least some of which are described elsewhere herein.

In some embodiments, the platinum alloy may have a particular hardness. The hardness of the platinum alloy may be measured using a Vickers hardness test. In some embodiments, the hardness of the platinum alloy (e.g., a binary platinum alloy, a ternary platinum alloy) is greater than or equal to 200 HV, greater than or equal to 300 HV, greater than or equal to 400 HV, greater than or equal to 500 HV, greater than or equal to 750 HV, or greater than or equal to 1000 HV. In some embodiments, the hardness of the platinum alloy is less than or equal to 1000 HV, less than or equal to 750 HV, less than or equal to 500 HV, or less than or equal to 400 HV. Combinations of the foregoing ranges are also possible (e.g., greater than or equal to 200 HV and less than or equal to 1000 HV). Of course, other ranges are possible as this disclosure is not so limited.

In some embodiments, the second element comprises or is selected from one of Zr, Ti, Ta, Mo, W, Fe, Co, Ni, Pd, Au, Ag, Cu, Mg, Al, P, B, Sn, Pb, Sb, and/or Bi. For example, in some embodiments the second element may is selected from the one of Mo, W, Pd, Au, Ag, Sb, and Bi. In certain embodiments, the platinum alloy is a Pt—W alloy. In certain embodiments, the platinum alloy is a Pt—Pd alloy. In certain embodiments, the platinum alloy is a Pt—Au alloy. Of course, other combinations of platinum and the second element are possible.

The second element may be present in the platinum alloy in any suitable amount. In some embodiments, an amount of the second element in the platinum alloy is less than or equal to 20 wt %, less than or equal to 15 wt %, less than or equal to 10 wt %, less than or equal to 5 wt %, less than or equal 3 wt %, or less than or equal to 1 wt %, with the remaining balance being platinum and/or a third element. In some embodiments, an amount of the second element in the platinum alloy is greater than or equal to 1 wt %, greater than or equal to 3 wt %, greater than or equal to 5 wt %, greater than or equal to 10 wt %, greater than or equal to 15 wt %, or greater than or equal to 20 wt %, with the remaining balance being platinum and/or a third element. Combinations of the foregoing ranges are also possible (e.g., greater than or equal to 1 wt % and less than or equal to 20 wt %). Other ranges are possible.

The platinum alloys described herein may include a third element. That is to say, in some embodiments, the platinum alloy is a ternary alloy containing platinum, a second element, and a third element. The third element may also be selected such that it reduces or prevents phase segregation and/or grain growth within the alloy. That is to say, the third element may also provide stability to the alloy such that the grain size of crystallites within the alloy maintain a particular structure (e.g., a nanostructure, a nanocrystalline structure). The third element may comprise or be selected from one of Zr, Ti, Ta, Mo, W, Fe, Co, Ni, Pd, Au, Ag, Cu, Mg, Al, P, B, Sn, Pb, Sb, and/or B. For example, in some embodiments, the third element comprises or is selected from the group consisting of Mo, W, Pd, Au, Ag, Sb, and Bi. In an exemplary embodiment, the second element is Au and the third element Pd, such that the alloy is a Pt—Au—Pd alloy. In certain embodiments, the platinum alloy is a Pt—Pd—Ni alloy. In certain embodiments, the platinum alloy is a Pt—Au—Ni alloy. In certain embodiments, the platinum alloy is a Pt—W—Co alloy. In certain embodiments, the platinum alloy is a Pt—W—Ni alloy. In certain embodiments, the platinum alloy is a Pt—W—Cu alloy. In certain embodiments, the platinum alloy is a Pt—Mg—Co alloy. In certain embodiments, the platinum alloy is a Pt—Mg—Cu. Of course, other combinations of the second and third element are possible and those skilled in the art in view of the present disclosure will be capable of selecting combinations of the second and third element of the platinum alloys.

The third element may be present in any suitable amount. In some embodiments, an amount of the third element in the platinum alloy is less than or equal to 10 wt %, less than or equal to 8 wt %, less than or equal to 6 wt %, less than or equal to 5 wt %, less than or equal 3 wt %, or less than or equal to 1 wt %, with the remaining balance being platinum and/or the second element. In some embodiments, an amount of the third element in the platinum alloy is greater than or equal to 1 wt %, greater than or equal to 3 wt %, greater than or equal to 5 wt %, greater than or equal to 6 wt %, greater than or equal to 8 wt %, or greater than or equal to 10 wt %, with the remaining balance being platinum and/or a second element. Combinations of the foregoing ranges are also possible (e.g., greater than or equal to 1 wt % and less than or equal to 10 wt %). Other ranges are possible.

The platinum-based alloys described above may include or be deposited (e.g., a coating) on a substrate. A variety of different substrates may be suitable. In some embodiments, the substrate may comprise an electrically conductive material, such as a metal, metal alloy, intermetallic material, or the like. Suitable substrate materials include steel, stainless steel, copper and copper alloys (e.g., brass or bronze materials), aluminum and aluminum alloys, nickel and nickel alloys, polymers with conductive surfaces and/or surface treatments, and transparent conductive oxides, without limitation. In some embodiments, the substrate may be formed from one material (e.g., a single material layer or a bulk material). In other embodiments, the substrate is formed of more than one layer of different materials.

In some embodiments, the platinum-based alloy can be a coating formed on the substrate. In some such embodiments, the coating covers substantially the entire outer surface area of the substrate. In some such embodiments, the coating covers only a portion of the outer surface area of the substrate. For example, the platinum alloy coating may only cover one outer surface of the substrate, and not necessarily all surfaces of the substrate. In some cases, portions of the substrate may be masked when forming the coating so that the coating is formed selectively on certain portions of the substrate while leaving other portions of the substrate uncoated. In some embodiments, one or more layers of a coating may be selectively deposited (e.g., using a mask) when being formed. That is, one or more layers may cover only a portion of the outer surface area of the underlying layer or substrate. Of course, other orientations of a coating on a substrate are possible as this disclosure is not so limited.

In some embodiments, the coating includes a top layer (i.e., the uppermost layer of the coating) which may be a metallic layer. In some embodiments, the top layer is formed directly on the substrate and the coating includes only a single layer. In other embodiments, the coating includes multiple layers, and the top layer is formed on one or more underlying layers which are formed on the substrate.

The platinum alloys (e.g., the nanocrystalline platinum alloys) described herein may be a component or a layer within an electrical contact or a stack of layers making up an electrical contact. For example, the stack may comprise a first layer (e.g., a first layer comprising nickel or a nickel alloy), a second layer (e.g., a second layer comprising a platinum alloy as disclosed herein) adjacent to the first layer, a third layer (e.g., a third layer comprising silver or a silver alloy) adjacent to the second layer, and/or a fourth layer (e.g., a fourth layer comprising a platinum alloy as disclosed herein). For example, a stack can comprise a Ni—W alloy as a first layer, a first nanostructure platinum alloy as the second layer, a silver alloy as the third layer, and second nanostructure platinum alloy as the fourth layer. In such embodiments, the first nanocrystalline platinum alloy and the second nanocrystalline platinum alloy may be the same or different. Other configurations of the layers are possible.

It should be understood that when a portion (e.g., layer, structure, region) is “on”, “adjacent,” “above,” “over,” “overlying,” or “supported by” another portion, it can be directly on the portion, or an intervening portion (e.g., an intervening layer, structure, or region) may also be present. Similarly, when a portion is “below” or “underneath” another portion, it can be directly below the portion, or an intervening portion (e.g., layer, structure, region) may also be present. A portion that is “directly adjacent”, “directly on”, “immediately adjacent”, “in contact with”, or “directly supported by” another portion means that no intervening portion is present. It should also be understood that when a portion is referred to as being “on”, “above”, “adjacent”, “over”, “overlying”, “in contact with”, “below”, or “supported by” another portion, it may cover the entire portion or a part of the portion.

In some embodiments the above-described layers (e.g., the first layer, the second layer, the third layer, and/or the fourth layer) may have an intervening layer positioned in between one or more pairs of layers. For example, the first layer and the second layer may have an intervening layer disposed in between them. In some embodiments, one or more intervening layers of the electrical contact or stack comprise gold (Au) and/or palladium (Pd). By way of illustration and not limitation, the stack may comprise a Ni—W alloy as a first layer, followed by an intervening layer of Au, followed by a nanocrystallineplatinum alloy as the second layer. As another non-limiting example, a stack can comprise a Ni—W alloy as a first layer, a first nanostructure platinum alloy as the second layer, a silver alloy as the third layer, second nanostructure platinum alloy as the fourth layer and, independently, each have an intervening layer of Au between the first layer and the second layer, between the second layer and the third layer, and between the third layer and the fourth layer, such that the configuration of the stack is Cu—Ni alloy/Au/a first nanocrystalline Pt alloy/Au/Ag alloy/a second nanocrystalline Pt alloy. In such embodiments, the first nanocrystalline Pt alloy and the second nanocrystalline Pt alloy can be the same or different. Other configurations of layers and intervening layers are possible.

The layers (e.g., the first layer, the second layer, the third layer, the fourth layer, an intervening layer) may independently be of any suitable thickness. In some embodiments, a layer (e.g., the first layer, the second layer, the third layer, the fourth layer, an intervening layer) has a thickness of greater than or equal to 0.5 microns, greater than or equal to 0.7 microns, greater than or equal to 1.0 micron, greater than or equal to 1.3 microns, greater than or equal to 1.5 microns, greater than or equal to 1.7 microns, greater than or equal to 2.0 microns, or greater than or equal to 2.5 microns. In some embodiments, a layer has a thickness of less than or equal to 2.5 microns, less than or equal to 2.0 microns, less than or equal to 1.7 microns, less than or equal to 1.5 microns, less than or equal to 1.3 microns, less than or equal to 1.0 micron, less than or equal to 0.7 microns, or less than or equal to 0.5 microns. Combinations of the foregoing ranges are also possible (e.g., greater than or equal to 0.5 microns and less than or equal to 2.0 microns). Other ranges are possible as this disclosure is not so limited.

The platinum alloys disclosed herein (e.g., nanostructure platinum alloys, Pt alloys within a stack) may be formed using an electrodeposition process. Electrodeposition generally involves the deposition of a material (e.g., electroplate) on a substrate by contacting the substrate with an electrodeposition bath and flowing electrical current between two electrodes through the electrodeposition bath, i.e., due to a difference in electrical potential between the two electrodes. For example, electrodeposition may involve providing an anode, a cathode, an electrodeposition bath (e.g., an electrolyte) associated with (e.g., in contact with) the anode and cathode, and a power supply connected to the anode and cathode. In some cases, the power supply may be driven to generate a waveform for producing a coating, as described in more detail below.

Generally, the different layers (e.g., metallic layers, alloy layers) may be applied using separate electrodeposition baths. In some cases, individual articles may be connected such that they can be sequentially exposed to separate electrodeposition baths, for example in a reel-to-reel process. For instance, articles may be connected to a common conductive substrate (e.g., a strip). In some embodiments, each of the electrodeposition baths may be associated with separate anodes and the interconnected individual articles may be commonly connected to a cathode.

In some embodiments, a layer which comprises platinum may be deposited from a bath which is acidic. In some embodiments, a layer which comprises platinum may be deposited from a bath which comprises a platinum ionic species, such as platinum chloride and/or platinum (II) diamine nitrate (Pt(NH₃)₂(NO₂)₂).

In some embodiments, a top layer which comprises platinum may be deposited from a bath which is acidic or basic. In some embodiments, a top layer which comprises platinum may be deposited from a bath which comprises chloroplatinic acid.

The electrodeposition process(es) may be modulated by varying the potential that is applied between the electrodes (e.g., potential control or voltage control), or by varying the current or current density that is allowed to flow (e.g., current or current density control). In some embodiments, the coating may be formed (e.g., electrodeposited) using direct current (DC) plating, pulsed current plating, reverse pulse current plating, or combinations thereof. In some embodiments, reverse pulse plating may be preferred. Pulses, oscillations, and/or other variations in voltage, potential, current, and/or current density, may also be incorporated during the electrodeposition process, as described more fully below. For example, pulses of controlled voltage may be alternated with pulses of controlled current or current density. In general, during an electrodeposition process an electrical potential may exist on the substrate (e.g., base material) to be coated, and changes in applied voltage, current, or current density may result in changes to the electrical potential on the substrate. In some cases, the electrodeposition process may include the use waveforms comprising one or more segments, wherein each segment involves a particular set of electrodeposition conditions (e.g., current density, current duration, electrodeposition bath temperature, etc.), as described more fully below.

Some embodiments may involve electrodeposition wherein the grain size of electrodeposited materials (e.g., metals, alloys, and the like) may be controlled. In some embodiments, selection of a particular coating (e.g., electroplate) composition, such as the composition of an alloy deposit, may provide a coating having a desired grain size. In some embodiments, electrodeposition methods (e.g., electrodeposition conditions) described herein may be selected to produce a particular composition, thereby controlling the grain size of the deposited material.

In some embodiments, a coating, or portion thereof, may be electrodeposited using direct current (DC) plating. For example, a substrate (e.g., electrode) may be positioned in contact with (e.g., immersed within) an electrodeposition bath comprising one or more species to be deposited on the substrate. A constant, steady electrical current may be passed through the electrodeposition bath to produce a coating, or portion thereof, on the substrate. In some embodiments, the potential that is applied between the electrodes (e.g., potential control or voltage control) and/or the current or current density that is allowed to flow (e.g., current or current density control) may be varied. For example, pulses, oscillations, and/or other variations in voltage, potential, current, and/or current density, may be incorporated during the electrodeposition process. In some embodiments, pulses of controlled voltage may be alternated with pulses of controlled current or current density. In some embodiments, the coating may be formed (e.g., electrodeposited) using pulsed current electrodeposition, reverse pulse current electrodeposition, or combinations thereof.

In some cases, a bipolar waveform may be used, comprising at least one forward pulse and at least one reverse pulse, i.e., a “reverse pulse sequence.” In some embodiments, the at least one reverse pulse immediately follows the at least one forward pulse. In some embodiments, the at least one forward pulse immediately follows the at least one reverse pulse. In some cases, the bipolar waveform includes multiple forward pulses and reverse pulses. Some embodiments may include a bipolar waveform comprising multiple forward pulses and reverse pulses, each pulse having a specific current density and duration. In some cases, the use of a reverse pulse sequence may allow for modulation of the composition and/or grain size of the coating or alloy that is produced.

It should be understood that other techniques may be used to produce coatings as described herein, including without limitation electroless plating processes, vapor-phase processes, (e.g. physical vapor deposition, chemical vapor deposition, ion vapor deposition, etc.), sputtering, spray coating, powder-based processes, slurry-based processes, etc.

The platinum alloys and multilayer stacks comprising the platinum alloys described herein may be resistant to corrosion, even when a voltage is applied to the platinum alloy and/or the multilayer stack. Accordingly, articles including the platinum alloys or multilayer coatings including the platinum alloys can exhibit desirable properties and characteristics including, for example, exceptional immersion corrosion properties. The sample (e.g., platinum alloys, articles coated with platinum alloys, stacks including platinum alloys) is immersed in a testing solution such as artificial perspiration (e.g., artificial perspiration manufactured according to ISO 3160) and a positive bias (e.g., 2 Volts, 5 Volts) is applied to the sample. The time to failure (e.g., in minutes) is measured.

There are several types of failure that may be characterized in different ways. As used herein, the time to “initial visible failure” is defined as the test time until the first visible signs of corrosion under 10x optical magnification.

As used herein, the time to “functional failure” is the test time until a connector formed from the sample no longer functions as defined by its mating surface having an LLCR (low level contact resistance) of greater than 10 mOhm when measured according to EIA-364-23B. In some embodiments, functional failure may be the test time until the mating surface has an LLCR of greater than 1 mOhm; in some embodiments, an LLCR of greater than 10 mOhm; in some embodiments, an LLCR of greater than 25 mOhm; in some embodiments, an LLCR of greater than 50 mOhm; in some embodiments, an LLCR of greater than 100 mOhm; and, in some embodiments, an LLCR of greater than 250 mOhm when measured according to EIA-364-23B. In some embodiments, the time to functional failure is the test time until a connector formed from the sample no longer functions as defined by its mating surface having a change in LLCR of greater than or equal to 1 mOhm; in some embodiments, a change in LLCR of greater than 10 mOhm; in some embodiments, a change in LLCR of greater than 20 mOhm; in some embodiments, a change in LLCR of greater than 50 mOhm; in some embodiments, a change in LLCR of greater than 100 mOhm; and, in some embodiments, a change in LLCR of greater than 250 mOhm, when measured according to EIA-364-23B.

As used herein, the time to “distinct corrosion” failure may be defined as the test time until the first corrosion product of a size and location as described in EIA-364-53B “Nitric Acid Vapor Test, Gold Finish Test Procedure for Electrical Connectors and Sockets” has a frequency of greater than 2%; in some embodiments, greater than 10%; in some embodiments greater than 15%; and, in some embodiments, greater than 25%.

Those of ordinary skill in the art will recognize that visible corrosion along the edges of an alloy or a multi-layer coating are often caused by “edge effects” and are often discounted as signs of failure during a given test. Those of ordinary skill in the art will also recognize that local processing defects, incorrect cleaning or activation of the sample prior to layer synthesis, or mechanically or chemically damaging exposures of the multi-layer coating prior to testing could cause a given test to be invalid regardless of the failure type being evaluated.

The exceptional immersion corrosion properties of articles including platinum alloys and multilayer coatings may be characterized by time(s) to failure in an immersion corrosion test. For example, in some embodiments, the time to failure (e.g., initial visible failure, functional failure and/or distinct corrosion failure) of the multilayer coated articles is at least 5 minutes at 5 V in artificial perspiration; in some embodiments, at least 10 minutes at 5 V in artificial perspiration; in some embodiments, at least 20 minutes at 5 V in artificial perspiration; in some embodiments, at least 40 minutes at 5 V in artificial perspiration; in some embodiments, at least 60 minutes at 5 V in artificial perspiration; and, in some embodiments, at least 100 minutes at 5 V in artificial perspiration. In some embodiments, the time to initial visible failure is less than 360 minutes at 5 V in artificial perspiration, less than 240 minutes at 5 V in artificial perspiration or less than 120 minutes at 5 V in artificial perspiration.

In some embodiments, the corrosion resistance may be assessed using tests such as ASTM B845, entitled “Standard Guide for Mixed Flowing Gas (MFG) Tests for Electrical Contacts” following the Class IIa protocol. These tests outline procedures in which coated substrate samples are exposed to a corrosive atmosphere (i.e., a mixture of NO₂, H₂S, Cl₂, and SO₂). The mixture of flowing gas can comprise 200+/−50 ppb of NO₂, 10+/−5 ppb of H₂S, 10+/−3 ppb of Cl₂, and 100+/−20 ppb SO₂. The temperature and relative humidity may also be controlled. For example, the temperature may be 30+/−1° C., and the relative humidity may be 70+/−2%.

The low-level contact resistance of a sample may be determined before and/or after exposure to a corrosive environment for a set period of time according to one of the tests described above. In some embodiments, the low-level contact resistance may be determined according to specification EIA 364-23B. In some embodiments, the coated article has reduced low-level contact resistance and/or change in low-level contact resistance after testing. Such articles may be particularly useful in electrical applications such as electrical connectors.

In some cases, the coated article may have a low-level contact resistance (LLCR) (under a load of 25 g) after 5 days exposure to mixed flowing gas according to ASTM B845, protocol Class IIa, of less than 250 mOhm; in some embodiments, less than 100 mOhm; in some embodiments, less than 50 mOhm; in some embodiments, less than 25 mOhm; in some embodiments, less than 10 mOhm; and in some embodiments, less than 1 mOhm.

In some cases, the coated article may have a change in low-level contact resistance (LLCR) (under a load of 25 g) after 5 days exposure to mixed flowing gas according to ASTM B845, protocol Class IIa, of less than 250 mOhm; in some embodiments, less than 100 mOhm; in some embodiments, less than 50 mOhm; in some embodiments, less than 20 mOhm; in some embodiments, less than 10 mOhm; and, in some embodiments, less than or equal to 1 mOhm.

The articles (e.g., platinum alloys, coatings comprising platinum alloys, stacks or multilayer configurations comprising platinum alloys) can be used in a variety of applications including electrical applications such as electrical connectors (e.g., plug-type) or cosmetic components (such as jewelry and eyeglass frames). Non-limiting examples of electrical connectors include infrared connectors, data and/or power connectors (e.g., USB connectors), video connectors (e.g., HDMI connectors), audio connectors (e.g., 3.5mm audio plug), battery chargers, battery contacts, automotive electrical connectors, etc.

The following example is intended to illustrate certain embodiments of the present invention, but do not exemplify the full scope of the invention.

### EXAMPLE

The following example describes the deposition and powered immersion corrosion resistance of a nanocrystalline Pt—W alloy.

The alloy coatings were electrodeposited from an aqueous-ammonia electrodeposition bath using an electrodeposition process. The electrodeposition bath contained the platinum ionic species, Pt(NH₃)₂(NO₂)₂, and the tungstate ionic species, Na₂WO₄.2H₂O. The coatings were deposited onto a copper substrate pretreated by ultrasonication in an alkaline solution, then electropolished in an acidic bath before being coated with copper from an acidic electrodeposition bath. A mixed metal-oxide anode was used. Table 1, below, outlines the conditions used for electrodeposition of the Pt—W alloy.

TABLE 1
Electrodeposition Conditions for a Nanocrystalline Pt—W Alloy

| Current Density (A/cm²) | Approx. 0.02 |
|---|---|
| Temperature (° C.) | 90 |
| Stirbar agitation (rpm) | 85 |
| anode composition | Inert mixed-metal oxide |
| pH | 8.80 |
| Pt concentration (g/L) | 3.75 |
| W concentration (g/L) | 2.50 |
| Plating rate (μm/min) | 0.025 |

A Pt—W alloy with thickness of 0.950 μm was electrodeposited onto the copper. The tungsten within the nanocrystalline platinum alloy was 0.45%-0.58%, as determined by EDX. The electrodeposited Pt—W alloy was bright-white and shiny without cracks, pores, or dendrites.

Powered immersion corrosion performance was determined by drawing voltage across four coated pins acting as an anode while partially submerged in an artificial sweat solution with pH 4.7 at room temperature. Stainless steel acted as the cathode, which was positioned approximately 0.5 cm from the anode pins. Following submersion in the simulated sweat for 21 minutes while providing 5V of power through the solution, the alloy remained intact with no signs of corrosion.

While several embodiments of the present invention have been described and illustrated herein, those of ordinary skill in the art will readily envision a variety of other means and/or structures for performing the functions and/or obtaining the results and/or one or more of the advantages described herein, and each of such variations and/or modifications is deemed to be within the scope of the present disclosure. More generally, those skilled in the art will readily appreciate that all parameters, dimensions, materials, and configurations described herein are meant to be exemplary and that the actual parameters, dimensions, materials, and/or configurations will depend upon the specific application or applications for which the teachings of the present disclosure is/are used. Those skilled in the art will recognize or be able to ascertain using no more than routine experimentation, many equivalents to the specific embodiments of the invention described herein. It is, therefore, to be understood that the foregoing embodiments are presented by way of example only and that, within the scope of the appended claims and equivalents thereto, the invention may be practiced otherwise than as specifically described and claimed. The present disclosure is directed to each individual feature, system, article, material, and/or method described herein. In addition, any combination of two or more such features, systems, articles, materials, and/or methods, if such features, systems, articles, materials, and/or methods are not mutually inconsistent, is included within the scope of the present disclosure.

1. An article, comprising:
a first layer comprising an alloy, the alloy comprising:
platinum (Pt); and
a second element comprising or selected from one of Mo, W, Pd, Au, Ag, Sb, and Bi,
wherein an average grain size of the alloy is less than or equal 1000 nm.

2. A method, comprising:
forming a first layer on a substrate, the first layer comprising an alloy comprising platinum (Pt) and a second element comprising or selected from one of Mo, W, Pd, Au, Ag, Sb, and Bi,
wherein an average grain size of the alloy is less than or equal 1000 nm.

3. The article of claim 1, further comprising a second layer comprising a nickel (Ni) alloy adjacent to the first layer.

4. The article of claim 1, further comprising a third layer, adjacent to the second layer, comprising a silver (Ag) alloy.

5. The article of claim 1, further comprising a fourth layer, adjacent to the third layer, comprising a second alloy, the second alloy comprising platinum (Pt) and an additional second element comprising or selected from one of Zr, Ti, Ta, Mo, W, Fe, Co, Ni, Pd, Au, Ag, Cu, Mg, Al, P, B, Sn, Pb, Sb, and Bi,
wherein an average grain size of the second alloy is less than or equal to 1000 nm.

6. The article of claim 1, further comprising a layer of gold and/or palladium between any one of the first layer, the second layer, the third layer, and/or the fourth layer.

7. The article of claim 1, further comprising a third element, different from the second element, selected from the group consisting of Ni, Pd, Au, W, Co, Cu, and Mg.

8. The article of claim 7, wherein the third element is Au.

9. The article of claim 1, wherein the alloy is nanocrystalline alloy.

10. The article of claim 1, wherein Pt is present in the alloy in the largest wt % relative to the second element and/or the third element.

11. The article of claim 1, wherein the second element is W or Pd.
